(19) United States
(12) Patent Application Publication
(10) Pub. No.: US 2002/0054377 A1
(43) Pub. Date: May 9, 2002

(54) Electronic board apparatus and data processing method for electronic board apparatus

(76) Inventors: Akihiro Ouchi, Kanagawa (JP); Yukihiko Sakashita, Kanagawa (JP); Shigehiro Kadota, Tokyo (JP)

Correspondence Address: FITZPATRICK CELLA HARPER & SCINTO, 30 ROCKEFELLER PLAZA, NEW YORK, NY, 10112, US

(21) Appl. No.: 09/930,453

(22) Filed: Aug. 16, 2001

(30) Foreign Application Priority Data
Aug. 23, 2000 (JP) 252821/2000
Aug. 2, 2001 (JP) 235184/2001

(51) Int. Cl. H04N 1/04

(52) U.S. Cl. 358/478

(57) ABSTRACT

The present invention relates to an electronic board apparatus. An electronic board apparatus of the present invention transmits data representing a handwritten image written on a predetermined board to an external computer. According to the present invention, it is determined whether or not the external computer can receive the data, and if it is determined that the external computer cannot receive the data, the data is stored in a memory provided in the electronic apparatus.

### FIELD OF THE INVENTION

The present invention relates to an electronified board apparatus which functions as a blackboard, a white board or the like, and more particularly, to an electronic board apparatus which outputs image information of character, figure and the like, handwrite-inputted on a predetermined board, as electronic data, to an external computer.

### BACKGROUND OF THE INVENTION

In a known electronic board apparatus, a handwritten image, inputted by using a writing tool on a writing surface of a white board, a writing sheet or the like, is read by a specialized scanner, and outputted to a print sheet by a specialized printer. For example, Japanese Published Unexamined Patent Application Nos. Hei 08-223331 and Hei 11-187177 disclose an electronic board apparatus which outputs image information as data read by a scanner to a personal computer or the like.

Further proposed is an electronic board apparatus having a digitizer in a writing surface of white board for inputting information, handwritten on the writing surface, into a personal computer in real time. For example, an optical digitizer or ultrasonic surface-acoustic-wave type digitizer is provided on the white board as a writing surface, and image data of character and/or image written on the white board is inputted in real time into the personal computer connected to the apparatus.

In the conventional electronic board apparatuses, as a general writing tool can be used for writing on the writing surface and the content of the input is duplicated, the function of the apparatus is intuitive and easily understood, and the effect of use is highly evaluated.

However, in the conventional electronic board apparatuses, as specialized software to input data to the personal computer is required, data transfer cannot be performed before the power of the personal computer is turned on and the specialized software is started.

Further, in the conventional electronic board apparatuses, to check a handwritten character or the like, it is necessary to check whether or not the input has been correctly made by watching the input displayed on a display screen of the external personal computer.

### SUMMARY OF THE INVENTION

The present invention has been made in consideration of the above situation, and has its object to provide an electronic board apparatus and a data processing method for the electronic board apparatus for transferring data in correspondence with a status of personal computer as a data transfer destination.

Further, another object of the present invention is to provide an electronic board apparatus and a data processing method for the electronic board apparatus for checking an input handwritten image without watching a display screen of personal computer as a data transfer destination.

According to the present invention, there is provided an electronic board apparatus for transmitting data representing a handwritten image written on a predetermined board to an external computer, comprising: means for determining whether or not the external computer can receive the data; and storage means for storing the data, wherein if it is determined that the external computer cannot receive the data, the data is stored into the storage means.

The electronic board apparatus of the present invention can further comprise display means for displaying said handwritten image based on said data.

Further, according to the present invention, there is provided an electronic board apparatus comprising:

data generation means for generating data representing a handwritten image written on a predetermined board;

means for transmitting the data to an external computer;

means for determining whether or not the external computer can receive the data; and storage means for storing the data, wherein if it is determined that the external computer cannot receive the data, the data is stored into the storage means.

The electronic board apparatus of the present invention can further comprise display means for displaying said handwritten image based on said data; and selection means for selecting one of a first mode and a second mode, wherein in said first mode, said display means displays said handwritten image based on said data from said data generation means, and wherein in said second mode, said display means displays said handwritten image based on said data stored in said storage means.

Further, according to the present invention, there is provided a data processing method for an electronic board apparatus for transmitting data representing a handwritten image written on a predetermined board to an external computer, comprising the steps of: determining whether or not the external computer can receive the data; and storing the data into storage means provided in the electronic board apparatus if it is determined that the external computer cannot receive the data.

The data processing method of the present invention can further comprise the step of displaying said handwritten image based on said data on a display provided on said electronic board apparatus.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an electronic board apparatus 1 and an external computer (PC) 30 according to a first embodiment of the present invention;

FIG. 2 is a flowchart showing processing executed by a CPU 22;

FIG. 3 is a flowchart showing communication processing between a digitizer 20 and the external computer 30;

FIG. 4 is a block diagram showing an electronic board apparatus 1′ and the external computer (PC) 30 according to a second embodiment of the present invention;

FIG. 5 is a flowchart showing display processing to display a handwritten image on a display device 27;

FIG. 6 is a perspective view of a personal computer 30 and a electronic board apparatus according to a first example of the present invention;

FIG. 7 is an explanatory view of communication control between the digitizer 20 and the personal computer 30;

FIG. 8 is a perspective view of a personal computer 30 and a electronic board apparatus 1′ according to a second example of the present invention; and

FIG. 9 is a perspective view of a digitizer 20′ according to a third example of the present invention.

### DETAILED DESCRIPTION OF THE PREFERRED EMBODIMENTS

Preferred embodiments of the present invention will now be described in detail in accordance with the accompanying drawings.

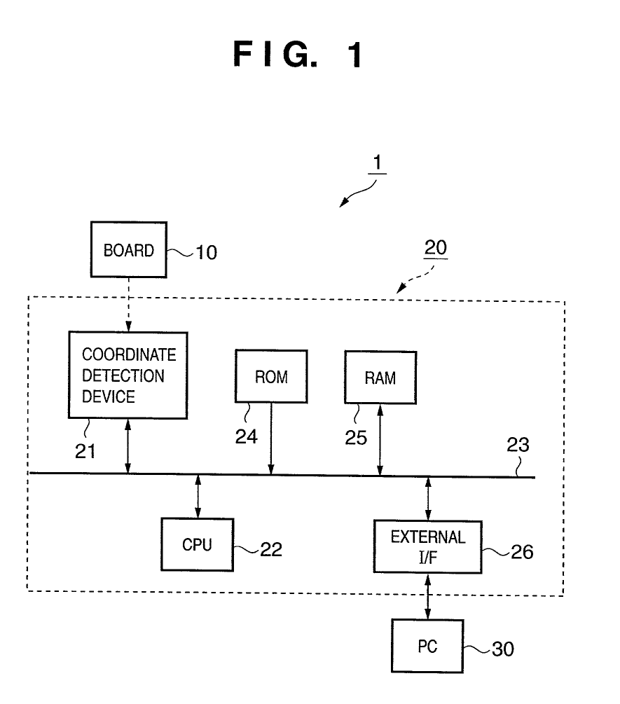

Hereinbelow, the first and second embodiments of the present invention will be described with reference to FIGS. 1 to 5.

First Embodiment

FIG. 1 is a block diagram showing an electronic board apparatus 1 and an external computer (PC) 30 according to a first embodiment of the present invention.

The electronic board apparatus 1 has a board 10 on which a character, a figure, a table and the like are written with a writing tool (not shown), and a digitizer 20 which generates computer-processable data based on the handwritten image written on the board 10.

The external computer 30 may comprise a general personal computer.

The electronic board apparatus 1 converts a handwritten image written on the board 10 into coordinate data by the digitizer 20, sequentially transmits the data to the external computer 30, then reproduce-displays the handwritten image on a display of the external computer 30 by using predetermined software. Thus the apparatus handles the handwritten image as electronic information in real time.

The digitizer 20 has a coordinate detection device 21 which generates coordinate data as data representing a handwritten image written on the board 10, a CPU 22 which controls the digitizer 20, a ROM 24, a RAM 25 in which coordinate data generated by the digitizer 20 is stored, and an external interface (external I/F) 26 for communication processing between the digitizer and the external computer 30. These elements are interconnected by a bus line 23.

In this construction, computer-processable data is generated from a handwritten image written on the board 10 as follows. For example, the memory space of the RAM 25 is matched with the writing space of the board 10, and data is written into the memory space corresponding to the coordinates of the image handwritten on the board 10. That is, assuming that the writing space is represented as horizontal a columns and vertical b rows, the memory space of the RAM 25 is a×b. The coordinates of the handwritten image are (X, Y)(X=0 to a−1, Y=0 to b−1), and the writing address to the RAM 25 is X+Y(1+a). Thus bitmap image data corresponding to the writing space of the board 10 can be generated.

Further, assuming that a movement of the writing tool to come into contact with the board 10 to move away from the board 10 is 1 stroke, stroke data may be generated as data of XY coordinate group upon sampling times within 1 stroke, or stroke data may be generated as data of information such as XY coordinates of input start position, the number of segments of drawing route, and lengths and directions of the respective segments.

Note that as the coordinate detection device 21, an optical digitizer as disclosed in Japanese Published Unexamined Patent Application Nos. Hei 06-274266, a ultrasonic surface-acoustic-wave type digitizer as disclosed in Japanese Published Examined Patent Application Nos. Hei 05-062771 or the like may be used.

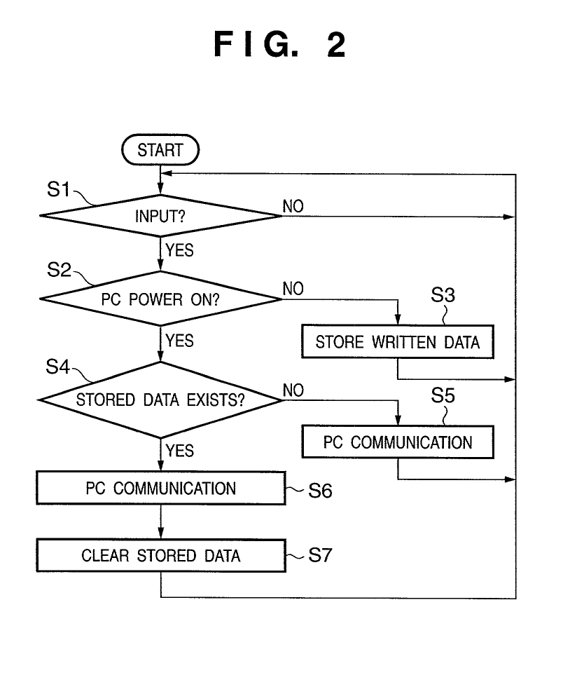

Next, processing executed by the CPU 22 will be described. A program of the processing executed by the CPU 22 is stored in the ROM 24. FIG. 2 is a flowchart showing the processing executed by the CPU 22.

When a power (not shown) of the digitizer 20 is turned ON, the electronic board apparatus 1 becomes operational.

At step S1, if a handwrite-input has been made on the board 10, coordinate data of handwritten image is generated by the coordinate detection device 21, and the process proceeds to step S2. At step S2, it is determined based on the status of the external computer 30 as data transmission destination whether or not the external computer can receive the data. In the present embodiment, it is checked whether or not a power of the external computer 30 is ON.

If it is determined that the power of the external computer 30 is not ON, the process proceeds to step S3, at which it is determined that the external computer cannot receive the data. The coordinate data generated by the coordinate detection device 21 is stored into the RAM 25, and the process returns to step S1.

If it is determined at step S2 that the power of the external computer 30 is ON, the process proceeds to step S4, at which it is determined that the external computer can receive the data. Then it is checked whether or not coordinate data is already stored in the RAM 25.

If no data is stored in the RAM 25, the process proceeds to step S5, at which the coordinate data generated by the coordinate detection device 21 is transmitted via the external I/F 26 to the external computer 30 in real time, while storage of the data into the RAM 25 is avoided, and the process returns to step S1.

If it is determined at step S4 that coordinate data is stored in the RAM 25, the process proceeds to step S6, at which the coordinate data stored in the RAM 25 is transmitted, with coordinate data of handwritten image inputted at that time, via the external I/F 26 to the external computer 30. Further, at step S7, the coordinate data stored in the RAM 25 is cleared, and the process returns to step S1.

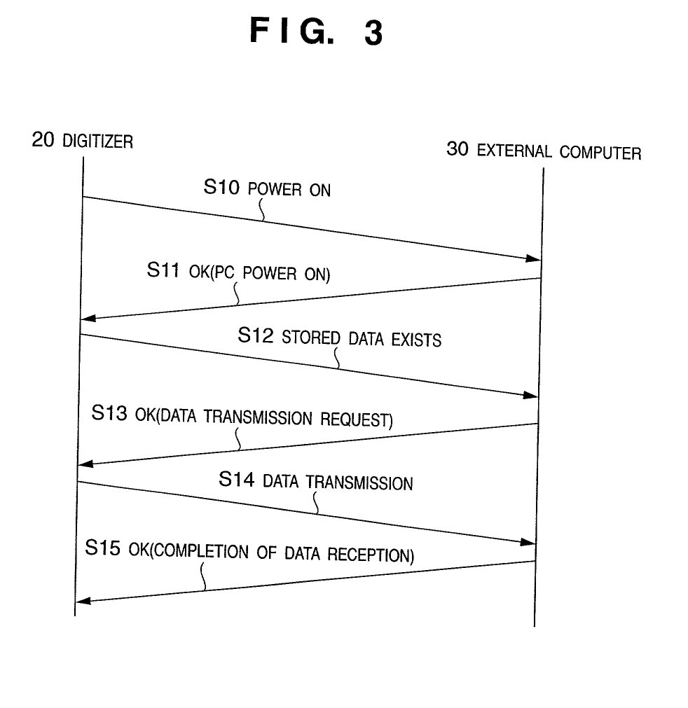

Next, communication processing between the digitizer 20 and the external computer 30 in the above processing will be described with reference to the flowchart of FIG. 3.

At step S10, the digitizer 20 notifies the external computer 30 that the power of the digitizer has been turned ON. The external computer 30, in response to the power-on of the digitizer 20, turns its power ON and starts electronic blackboard software.

At step S11, the external computer 30 notifies the digitizer 20 that a data reception status has been prepared. At step S12, if a handwrite-input has been made before the external computer 30 becomes operational, the digitizer 20 notifies the external computer 30 that coordinate data is stored in the RAM 25.

At step S13, in response to the notification, the external computer 30 makes a request for transmission of the stored coordinate data. At step S14, in response to the transmission request from the external computer 30, the digitizer 20 transmits the coordinate data stored in the RAM 25.

At step S15, the external computer 30 notifies the digitizer 20 of the completion of data reception. Thereafter, transmission/reception of data is made in real time.

In this manner, in the electronic board apparatus of the present embodiment, if the power of the digitizer 20 is turned ON and handwriting is started when the power of the external computer 30 is not ON, coordinate data generated by the coordinate detection device 21 is temporarily stored into the RAM 25.

On the other hand, in response of the power-on of the digitizer 20, the external computer 30 turns the power ON and starts the predetermined software for the electronic board apparatus 1. Upon completion of start-up of the predetermined software, the coordinate data stored in the RAM 25 is inputted into the external computer 30 and displayed there. When the external computer 30 is operational, coordinate data of handwritten image can be inputted into the external computer 30 in real time.

Accordingly, coordinate data is transferred in correspondence with the status of the external computer 30 as the data transfer destination, even before the external computer 30 becomes ready for reception of coordinate data, a handwrite-input can be made to the board 10.

Second Embodiment

On the other hand, as the handwritten image inputted into the board 10 before the external computer 30 has become operational is not displayed on the external computer 30, it cannot be immediately checked whether or not the input has been correctly made.

In the second embodiment of the present invention, the digitizer 20 is provided with a display device such that a handwritten image can be checked.

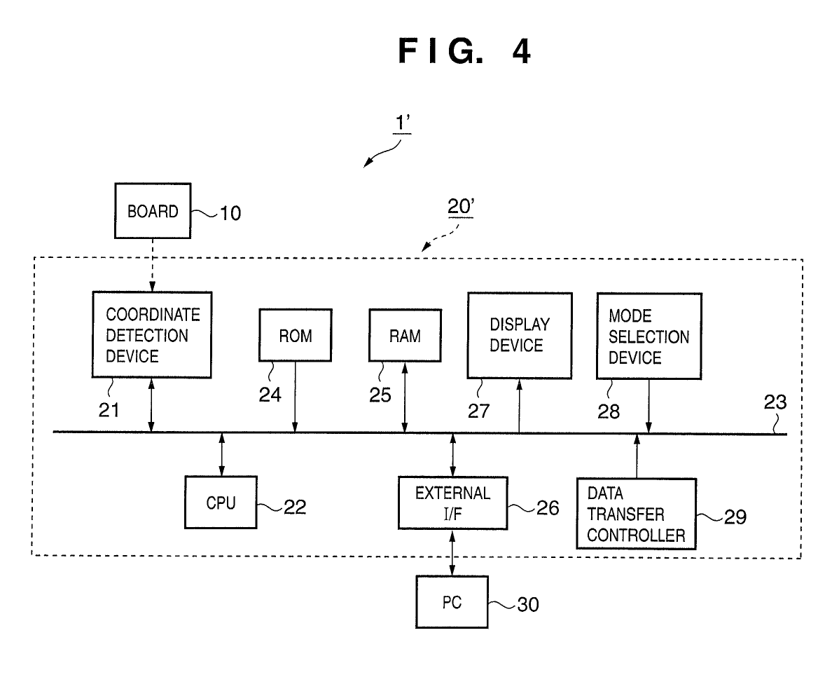

FIG. 4 is a block diagram showing an electronic board apparatus 1′ and the external computer (PC) 30 according to the second embodiment of the present invention. In the figure, elements having the same functions as those in FIG. 1 have the same reference numerals.

In FIG. 4, a display device 27, a mode selection device 28 and a data transfer controller 29 are connected to the bus line 23 of a digitizer 20′. The data transfer controller 29 arbitrarily controls timing to transfer coordinate data stored in the RAM 25 to the external computer 30.

In the present embodiment, the display device 27 such as an LCD is provided in the digitizer 20′, however, the external display device may be connected to the digitizer 20′.

The mode selection device 28 selects one of a first mode to sequentially transmit coordinate data of handwritten image written on the board 10 to the display device 27 and a second mode to transmit coordinate data stored in the RAM 25 to the display device 27.

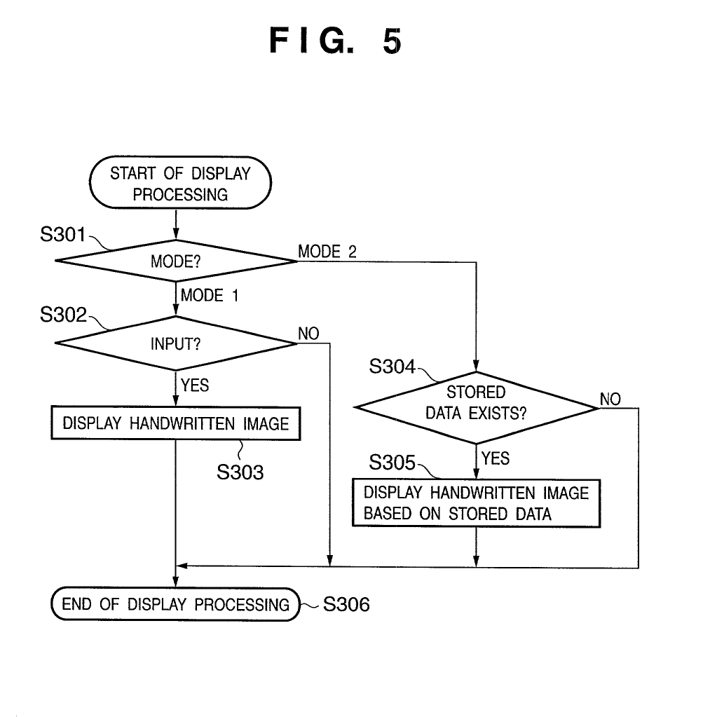

FIG. 5 is a flowchart showing display processing to display a handwritten image on the display device 27. When the power of the digitizer 20′ is turned ON, the CPU 22 executes the display processing.

At step S301, the status of the mode selection device 28 for mode selection is checked. If it is determined that the mode selection device 28 selects the first mode, the process proceeds to step S302. When a handwrite-input is made at step S302, the process proceeds to step S303, at which a handwritten image is displayed on the display device 27 based on coordinate data generated by the coordinate detection device 21.

If it is determined at step S301 that the second mode is selected, the process proceeds to step S304. At step S304, the storage content in the RAM 25 is checked. If coordinate data is stored, a handwritten image is displayed on the display device 27 based on the coordinate data stored in the RAM 25.

As described above, according to the present embodiment, as the digitizer 20 is provided with the display device 27, it can be immediately checked without the external computer 30 whether or not a correct input has been made.

Further, if the second mode is selected to display the content of the RAM 25 on the display device 27, data currently stored in the RAM 25 can be checked. Further, as the data transfer controller 29 is provided, the data in the RAM 25, that has been checked by using the display device, can be transmitted to the external computer.

### EXAMPLES

Hereinbelow, examples of the present invention will be described.

### First Example

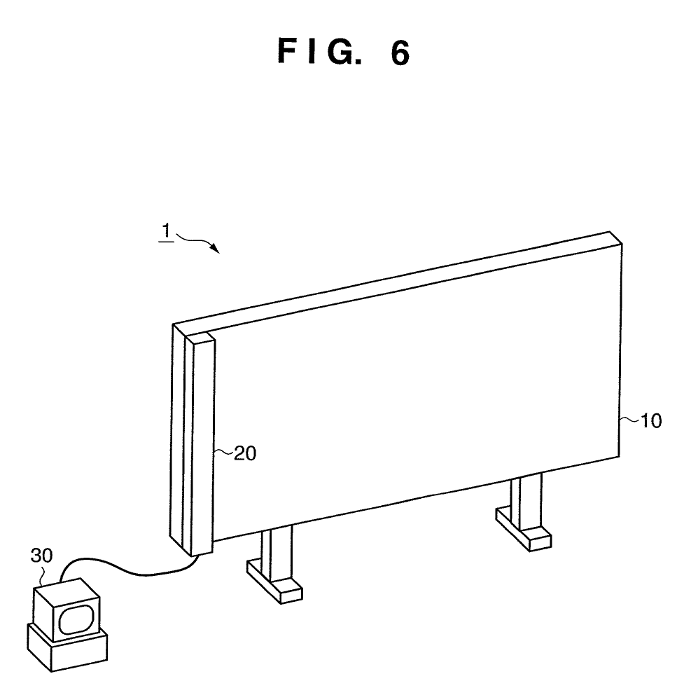

The first example corresponds to the first embodiment. FIG. 6 is a perspective view of the personal computer 30 and the electronic board apparatus 1 according to the first example.

In the present example, a general white board 10 is employed as the board 10 for inputting a handwritten image.

Further, an ultrasonic surface-acoustic-wave type digitizer is employed as the digitizer 20. The digitizer is provided at one end of the white board 10. Coordinate data generated by the digitizer 20 is transmitted to the personal computer 30 as the external computer, and handled as electronic data by electronic board software running on the OS of the personal computer 30.

Note that the digitizer 20 may be fixed to the board 10, however, in the present example, the digitizer is removable. Although the white board is used as the board 10 and the digitizer 20 is provided on the board in the present example, the digitizer may be provided on another white board, or may be provided on a wall or the like such that the digitizer detects an input to a sheet of paper attached to the wall. Thus the present apparatus can be utilized without the board.

Further, the personal computer 30 has a power control circuit such that when the power of the digitizer 20 is turned ON, the power of the personal computer is turned ON by a control signal from the digitizer 20.

Further, as shown in FIG. 1, the digitizer 20 has a memory for storing coordinate data detected by the coordinate detection device 21 such that coordinate data of handwritten image, which has been handwrite-inputted between the power-on of the digitizer 20 and the power-on of the personal computer, is stored into the memory.

Further, the personal computer 30 and the digitizer 20 may be interconnected via a USB (Universal Serial Bus). By this USB connection, the respective functions of the electronic blackboard software and the digitizer 20 can be logically directly communicate with each other. When the personal computer 30 has become operational, the personal computer 30 is a host computer.

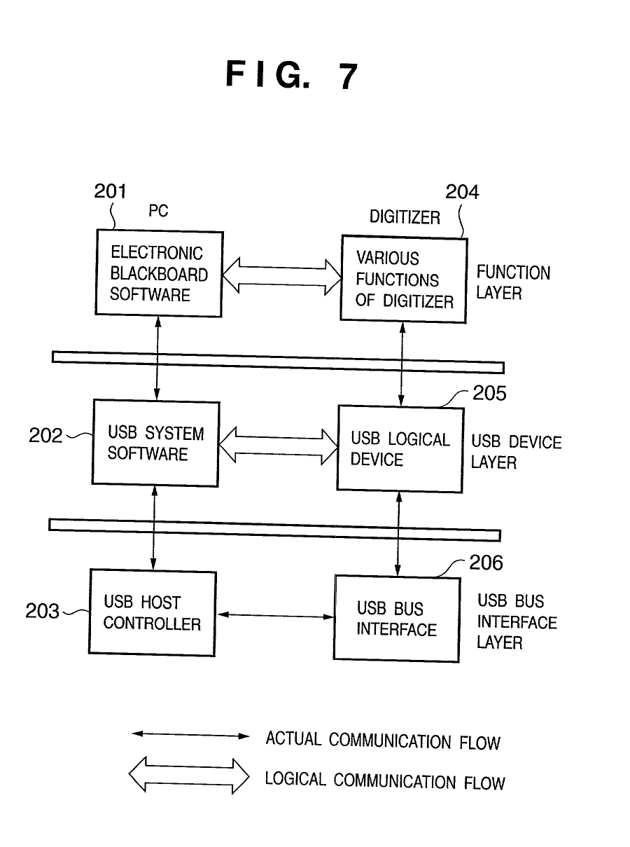

The communication control between the digitizer 20 and the personal computer 30 will be described with reference to FIG. 7. In FIG. 7, reference numeral 201 denotes electronic blackboard software at the highest layer executed on the personal computer; 202, a USB System Software at an intermediate layer to control the hardware; 203, a USB HOST controller at the lowest layer including the hardware; 204, the respective functions of the digitizer 20 at the highest layer; 205, a USB logical device at the intermediate layer; and 206, a USB bus interface at the lowest layer.

When the power of the personal computer is turned ON and the electronic blackboard software 201 starts, the electronic blackboard software 201 issues a check command to check whether or not coordinate data is stored in the memory to the USB System Software 202. Then the USB System Software 202 issues the check command to the USB Host Controller 203.

The USB Host Controller 203 communicates with the USB Bus Interface 206 in accordance with the USB protocol and transmits the check command. The USB Bus Interface 206 receives the check command and transmits the check command to the USB logical device 205 of the digitizer, and the USB logical device 205 forwards the command to the corresponding function 204 of the digitizer 20.

If storage means management function 204 prepared as the function of the digitizer 20 returns the presence/absence of stored coordinate data to the electronic blackboard software 201, the storage means management function 204 issues data indicating the presence/absence of stored coordinate data to the USB logical device 205.

The USB logical device 205 forwards the data indicating the presence/absence of stored coordinate data, received from the storage means management function 204 of the digitizer 20, to the USB Bus Interface 206. The USB Bus Interface 206 receives the signal, communicates with the USB Host Controller 203 in accordance with the USB protocol, and transmits the data indicating the presence/absence of stored coordinate data to the USB Host Controller 203. The USB Host Controller 203 receives the data and transmits the data to the USB System Software 202, and the USB System Software 202 transmits the data indicating the presence/absence of stored coordinate data to the electronic blackboard software 201. By the above communication, the coordinate data, handwrite-inputted and stored into the memory before the power-on of the personal computer, is sent to the electronic blackboard software 201. Handwrite-inputs after the power-on of the personal computer are sequentially sent to the electronic blackboard software 201.

Note that in this example, the personal computer with the power control circuit is employed such that the power of the personal computer is actively controlled from the digitizer, however, it may be arranged such that the digitizer and the personal computer share the power and the power is turned on in one position. Further, the connection between the digitizer and the personal computer is made by USB, however, the connection is not limited to the USB connection, but connection by IEEE1394, Bluetooth or the like may be used.

Next, the operation of the present example will be described.

If a handwrite-input is started in a status where the power of the digitizer has been turned ON but the power of the personal computer is not turned ON, coordinate data of the inputted handwritten image is temporarily sequentially stored into the memory in the digitizer. When the power of the personal computer is turned ON and the electronic blackboard software is started, it is checked whether or not coordinate data is stored in the memory of the digitizer. If coordinate data is stored, the information is automatically read. Thereafter, handwrite-inputted information are sequentially inputted into the personal computer.

As described above, according to the present example, the function as the electronic board apparatus can be used only by turning on the power of the digitizer, without waiting until the personal computer becomes operational.

### Second Example

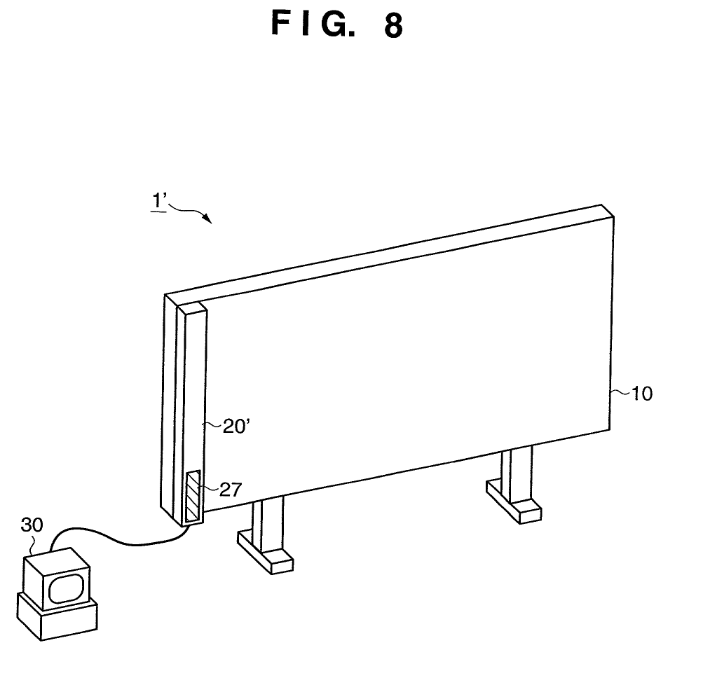

The second example corresponds to the second embodiment. FIG. 8 is a perspective view of the personal computer 30 and the electronic board apparatus 1′ according to the second example.

In the present example, an electronic board apparatus similar to that of the first example is employed, however, a liquid crystal display panel 27 is mounted on the digitizer 20′ as shown in FIG. 8. Note that the liquid crystal display panel 27 is the display device in FIG. 4, and as the function of the display panel has been already described, the explanation of the function will be omitted.

The liquid crystal display panel 27 may have a display capacity for displaying only an input part if the use of the display panel is limited to check the input. Otherwise, the display panel may have a large capacity to display the entire writing surface. According to the present example, as a handwritten image is displayed on the liquid crystal display panel 27, it can be checked whether or not an input has been correctly made.

### Third Example

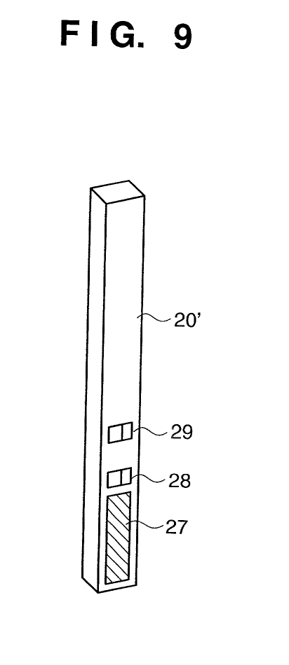

The third example also corresponds to the second embodiment. In the present example, an electronic board apparatus similar to that of the second example is employed, however, the digitizer 20′ is provided with a mode selection switch 28 and a data transfer start switch 29, as shown in FIG. 9. Note that the mode selection switch 28 corresponds to the mode selection device 28 in FIG. 4, and the data transfer start switch 29, to instruct to transfer coordinate data stored in the RAM 25, corresponds to the data transfer controller 29 in FIG. 4. As the functions of these elements have been already described, the explanations of the functions will be omitted.

In this example, as the switches 28 and 29, mechanical switches are provided on the digitizer 20′. In this construction, positions of the switches can be easily found and operations thereof can be easily made. Further, these switch functions may be realized by adding a touch panel to the liquid crystal display panel 27 mounted on the digitizer 20′ and providing selection icons or a menu. In this case, a graphic interface can be constructed on the liquid crystal display panel 27 for improvement in operability and appearance.

Note that the functions of the mode selection switch 28 and the data transfer start switch 29 can be more effective by adding index information such as page brake to coordinate data stored in the RAM 25. In this case, data can be stored into the RAM 25 by plural pages or index. Further, the contents of the stored coordinate data can be independently displayed, thereby visual identification of data or search can be easily made. Further, if a removable memory card is employed as the RAM 25 for storing coordinate data, plural digitizer information can be used regardless of the memory capacity. In this case, the apparatus has excellent portability, and data can be transferred to the external computer only by moving the memory card.

According to the present example, similar advantages to those of the second example can be attained, and further, the apparatus can be used as a simple electronic board apparatus even if the apparatus is not connected to the personal computer.

As many apparently widely different embodiments of the present invention can be made without departing from the spirit and scope thereof, it is to be understood that the invention is not limited to the specific embodiments thereof except as defined in the appended claims.

What is claimed is:

1. An electronic board apparatus for transmitting data representing a handwritten image written on a predetermined board to an external computer, comprising:
means for determining whether or not said external computer can receive said data; and
storage means for storing said data,
wherein if it is determined that said external computer cannot receive said data, said data is stored into said storage means.

2. The electronic board apparatus according to claim 1, wherein if it is determined that said external computer can receive said data, said data is not stored into said storage means but transmitted to said external computer.

3. The electronic board apparatus according to claim 1, further comprising means for determining whether or not said data is stored in said storage means,
wherein if it is determined that said data is stored in said storage means, said data is transmitted to said external computer.

4. The electronic board apparatus according to claim 1, wherein said handwritten image includes at least one of a character, a figure and a table.

5. The electronic board apparatus according to claim 1, wherein data representing said handwritten image is data of coordinate information of said handwritten image.

6. The electronic board apparatus according to claim 1, further comprising display means for displaying said handwritten image based on said data.

7. The electronic board apparatus according to claim 6, wherein said display means displays said handwritten image based on said data stored in said storage means.

8. The electronic board apparatus according to claim 1, wherein a display device to display said handwritten image based on said data is connectable to said apparatus.

9. The electronic board apparatus according to claim 1, further comprising data transfer control means for controlling timing of transmission of data to said external computer.

10. The electronic board apparatus according to claim 1, wherein said data, to which page brake or index information is added, is stored.

11. The electronic board apparatus according to claim 1, wherein said data storage means is a removable memory card.

12. The electronic board apparatus according to claim 1, wherein said electronic board apparatus is provided at one end of said board.

13. The electronic board apparatus according to claim 1, wherein said electronic board apparatus is removable from said board.

14. An electronic board apparatus comprising:
data generation means for generating data representing a handwritten image written on a predetermined board;
means for transmitting said data to an external computer;
means for determining whether or not said external computer can receive said data; and
storage means for storing said data,
wherein if it is determined that said external computer cannot receive said data, said data is stored into said storage means.

15. The electronic board apparatus according to claim 14, further comprising:
display means for displaying said handwritten image based on said data; and
selection means for selecting one of a first mode and a second mode,
wherein in said first mode, said display means displays said handwritten image based on said data from said data generation means,
and wherein in said second mode, said display means displays said handwritten image based on said data stored in said storage means.

16. A data processing method for an electronic board apparatus for transmitting data representing a handwritten image written on a predetermined board to an external computer, comprising the steps of:
determining whether or not said external computer can receive said data; and
storing said data into storage means provided in the electronic board apparatus if it is determined that said external computer cannot receive said data.

17. The data processing method according to claim 16, further comprising the step of displaying said handwritten image based on said data on a display provided on said electronic board apparatus.
